(19) United States
(12) Patent Application Publication
(10) Pub. No.: US 2015/0019344 A1
(43) Pub. Date: Jan. 15, 2015

(54) Flyer Approval and Distribution System

(71) Applicant: PeachJar, Inc., San Diego, CA (US)

(72) Inventor: Michael D. Durham, Poway, CA (US)

(73) Assignee: PEACHJAR, INC., San Diego, CA (US)

(21) Appl. No.: 14/332,257

(22) Filed: Jul. 15, 2014

Related U.S. Application Data
(60) Provisional application No. 61/846,566, filed on Jul. 15, 2013.
(60) Provisional application No. 61/912,526, filed on Dec. 5, 2013.

(51) Int. Cl. G06Q 30/02

(52) U.S. Cl. CPC G06Q 30/0277; G06Q 30/0269
USPC 705/14.66

(57) ABSTRACT

An entity of a plurality of entities with a flyer recipient account of a plurality of flyer recipient accounts with flyer-to-recipient matching attributes. A data structure that includes an electronic version of a flyer with flyer-to-recipient matching attributes is received. At least a portion of the flyer is provided to a flyer approver according to approval rules for the flyer. The flyer is distributed to a flyer recipient with the flyer recipient account through flyer reception channel for the flyer recipient if it is determined that the flyer is approved by the flyer approver and the flyer-to-recipient matching attributes of the flyer correspond to flyer-to-recipient matching attributes of the flyer recipient account.

### CROSS-REFERENCE TO RELATED APPLICATIONS

The present application claims priority to U.S. Provisional Patent Application Ser. No. 61/846,566, filed on Jul. 15, 2013 and entitled “Flyer Approval and Distribution,” and U.S. Provisional Patent Application Ser. No. 61/912,526, filed on Dec. 5, 2013 and entitled “Flyer Approval and Distribution System,” which are hereby incorporated by reference herein.

### BACKGROUND

An area of ongoing research and development is delivery of information to people in electronic formats. While various social networks have been developed allowing for widespread sending of information to users there exists a need for distribution of flyers to people in an electronic format. However, it has proven difficult to provide a platform that enables distribution of flyers, and systems that include distribution of physical fliers are prevalent in many industries today such as, for example, schools, medical facilities, and the like. Accordingly, inadequate logistics has prevented the growth of electronic flyer systems.

Another unmet need in the prior art is the anonymity of flyer recipients. While it is not always necessary for a flyer recipient to be anonymous when selecting a flyer, privacy may be a compelling concern. Electronic flyer delivery systems today generally fail to provide the anonymity or other privacy controls a flyer recipient might wish to have. This alone has prevented electronic flyer delivery to extend beyond having potential recipients simply sign up for a mailing list or having to visit a web site to download a flyer.

An additional problem is that often times, flyers must be approved before being distributed. Flyers are often produced by relatively complex business entities that have different parties responsible for creating, approving, and distributing flyers. There therefore exists a need for systems and methods for conveniently approving flyers in electronic format as part of a flyer generation, approval, and distribution system with adequate quality control.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Various implementations include systems and methods for flyer approval and distribution. In various implementations, an entity of a plurality of entities with a flyer recipient account of a plurality of flyer recipient accounts with flyer-to-recipient matching attributes. Additionally, in various implementations, a data structure that includes an electronic version of a flyer with flyer-to-recipient matching attributes is received. In various implementations, at least a portion of the flyer is provided to a flyer approver according to approval rules for the flyer. Further, in various implementations, the flyer is distributed to a flyer recipient with the flyer recipient account through flyer reception channel for the flyer recipient if it is determined that the flyer is approved by the flyer approver and the flyer-to-recipient matching attributes of the flyer correspond to flyer-to-recipient matching attributes of the flyer recipient account.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for approving and distributing flyers.

FIG. 2 depicts a diagram of an example of a system for registering a flyer recipient.

FIG. 3 depicts a diagram of an example of a system for gaining approval for a flyer.

FIG. 4 depicts a diagram of an example of a system for determining whether approval to distribute a flyer exists and distributing the flyer if approval does exist.

FIG. 5 depicts a diagram of an example of a system for generating approval rules and approval hierarchies.

FIG. 6 depicts a flowchart of an example of a method for gaining approval to distribute a flyer and distributing the flyer.

FIG. 7 depicts a flowchart for sending a flyer to flyer approvers to gain approval to distribute the flyer.

FIG. 8 depicts a flowchart for determining whether approval exists to distribute a flyer to an appropriate flyer recipient exists and distributing the flyer to the appropriate flyer recipient.

FIG. 9 depicts a flowchart of an example of a method for approving and distributing flyers to flyer recipients.

FIG. 10 depicts an example of a screenshot of an interface through which a user can login to a system for flyer approval and distribution.

FIG. 11 depicts an example of a screenshot of a homepage of a user in a system for flyer approval and distribution.

FIG. 12 depicts an example of a screenshot of a flyer approval homepage in a system for flyer approval and distribution.

FIG. 13 depicts an example of a screenshot of a pending flyer approval page in a system for flyer approval and distribution.

FIG. 14 depicts an example of a screenshot of another pending flyer approval page in a system for flyer approval and distribution.

FIG. 15 depicts an example of a screenshot of another pending flyer approval page in a system for flyer approval and distribution.

FIG. 16 depicts an example of a screenshot of a flyer approver assignment page in a system for flyer approval and distribution.

### DETAILED DESCRIPTION

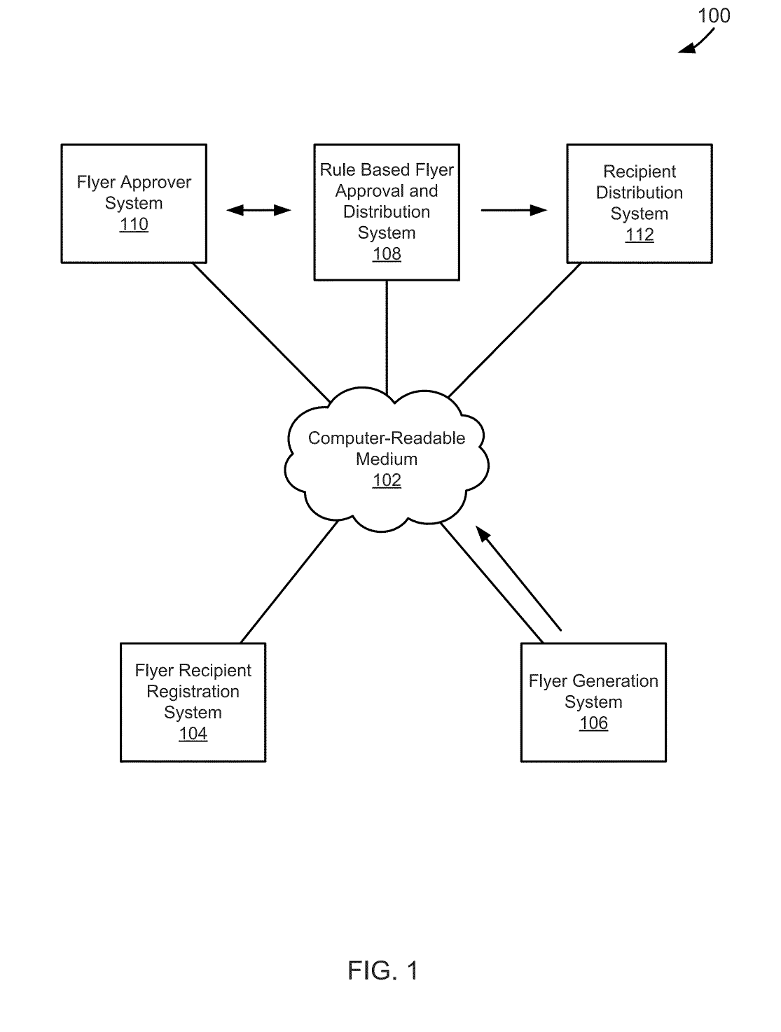

FIG. 1 depicts a diagram 100 of an example of a system for approving and distributing flyers. The system of the example of FIG. 1 includes a computer-readable medium 102, a flyer recipient registration system 104, a flyer generation system 106, a rule based flyer approval and distribution system 108, a flyer approver system 110, and a recipient distribution system.

The flyer recipient registration system 104, the flyer generation system 106, the rules based flyer approval and distribution system 108, the flyer approver system 110, and the recipient distribution system 112 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the flyer recipient registration system 104, the flyer generation system 106, the rule based flyer approval and distribution system 108, the flyer approver system 110, the recipient distribution system 112, and other systems, or devices described in this paper can be implemented as a computer system or parts of a computer system or a plurality of computer systems. A computer system, as used in this paper, can include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can be a specific purpose engine that includes specific purpose hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the flyer recipient registration system 104 functions to register a flyer recipient for receiving distributed flyers. In registering a flyer recipient, the flyer recipient registration system 104 can function to generate registrant data. Registrant data can include the identification of a flyer recipient, and/or flyer-to-recipient matching attributes used to associate an entity with a flyer recipient. For example, if the flyer recipient has a child who attends a school, then the registrant data can include the identification of the school and/or school district of the school. Additionally, registrant data can include the contact information of a flyer recipient. For example, the registrant information can include the email address, or a telephone number of the flyer recipient. Furthermore, the registrant data can include flyer reception channel indicators for the flyer recipient. For example, if the flyer recipient prefers to receive and access flyers through email, then the registrant data can indicate that email is the preferred distribution channel. In another example, if the flyer recipient prefers to access flyers through a webpage and receive emails notifying the flyer recipient that flyers have been distributed to them, then the registrant data can indicate that the flyer recipient prefers to access flyers through a webpage and receive email notifications. The registrant data can also include types of flyers that the flyer recipient wants to receive and types of flyers that the flyer recipient does not want to receive. For example, if the flyer recipient does not want to receive flyers about after school programs, then the registrant data can specify that the flyer recipient does not want to receive flyers about after school programs.

In a specific implementation, the flyer generation system 106 functions to generate and/or upload flyer data. In generating and/or uploading flyer data, the flyer generation system 106 can generate an electronic version of a flyer included as part of flyer data. The flyer generation system 106 can be part of or associated with an entity for which a flyer is created. For example, the flyer generation system 106 can be a school within a school district for which a flyer is created. The flyer generation system 106 can generate a flyer that includes both text and images. Depending upon implementation-specific or other considerations, the flyer generation system 106 can upload a flyer included as part of flyer data by uploading the flyer data.

In a specific implementation, the rules based flyer approval and distribution system 108 functions to gain approval for a flyer, included as part of flyer data. In gaining approval for a flyer, the flyer approver system can determined flyer approvers that need to approve a flyer according to approval rules. Depending upon implementation-specific or other considerations, approval rules can be unique to a flyer based on a flyer type of the flyer, an entity associated with the flyer, and/or a generator of the flyer. Further depending upon implementation-specific or other considerations, approval rules can be unique to a flyer based on an approval hierarchy and hierarchy conditions.

In a specific implementation, the flyer approver system 110 functions to allow a flyer approver to approve a flyer. In allowing a flyer approver to approve a flyer, the flyer approver system 110 can receive at least a portion of a flyer from the rule based flyer approval and distribution system 108. Further in allowing a flyer approver to approve a flyer, the flyer approver system 110 can send approval data indicating whether the flyer approver approves a flyer.

In a specific implementation, the rules based flyer approval and distribution system 108 functions to determine whether a flyer is approved. In determining whether a flyer is approved, the rule based flyer approval and distribution system 108 can receive approval data from the flyer approver system 110. Additionally, in determining whether a flyer is approved, the rule based flyer approval and distribution system 108 can determine whether appropriate approval for the flyer exists in accordance with approval rules for the flyer. Depending upon implementation-specific or other considerations, the rule based flyer approval and distribution system 108 can determine whether appropriate approval exists for a flyer according to an approval hierarchy and approval conditions for a flyer. For example, if an approval hierarchy specifies that approval from a second flyer approver is needed after approval is received from a first flyer approver, and the rule based flyer approval and distribution system 108 determines that approval exists from the first flyer approver and the second flyer approver, then the rules based flyer approval and distribution system 108 can determine that appropriate approval for the flyer exists. The rule based flyer approval and distribution system 108 functions to send the flyer to an applicable system for distribution of the flyer if it determines that appropriate approval exists for the flyer.

In a specific implementation, the recipient distribution system 112 functions to distribute a flyer if the flyer is approved. Depending upon implementation-specific or other considerations, the recipient distribution system 112 can receive a flyer from the rules based flyer approval and distribution system 108 after the flyer is approved and subsequently distributes the flyer to appropriate flyer recipients. Further depending upon implementation-specific or other considerations, the recipient distribution system 112 can be integrated as part of the rule based flyer approval and distribution system 108 or separate from the rule based flyer approval and distribution system 108.

In a specific implementation, the recipient distribution system 112 functions to determine appropriate flyer recipients for a flyer. Depending upon implementation-specific or other considerations, the recipient distribution system 112 can determine appropriate flyer recipients based on flyer-to-recipient matching attributes of a flyer that correspond to flyer-to-recipient matching attributes of a flyer. For example, if flyer-to-recipient matching attributes of a flyer include that the flyer is for a specific school, and flyer-to-recipient matching attributes include that parent has a student at the specific school, then the recipient distribution system 112 can determine that the parent is an appropriate flyer recipient for the flyer. The recipient distribution system 112 can distribute or otherwise make available a flyer to appropriate flyer recipients determined for the flyer.

In a specific implementation, the recipient distribution system 112 functions to determine a flyer reception channel for a flyer recipient. A flyer reception channel for a flyer recipient can include a preferred distribution channel through which the flyer recipient wishes to receive flyers. Depending upon implementation-specific or other considerations, the recipient distribution system 112 can determine a flyer reception channel for a flyer recipient according to flyer reception channel indicators, included as part of registrant data for the flyer recipient, e.g. registrant data generated by the flyer recipient registration system 104.

In an example of operation of the example system shown in FIG. 1, the flyer recipient registration system 104 registers a flyer recipient. In the example of operation of the example system shown in FIG. 1, the rule based flyer approval and distribution system 108 receives a flyer, included as part of flyer data from the flyer generation system 106. Further in the example of operation of the example system shown in FIG. 1, the rule based flyer approval and distribution system 108 determines appropriate flyer approvers to approve the flyer according to approval rules for the flyer. In the example of operation of the example system shown in FIG. 1, the rule based flyer approval and distribution system 108 sends at least a portion of the flyer to the flyer approver system 110 and receives approval data back from the flyer approver system 110 indicating whether the flyer is approved. In the example of operation of the example system shown in FIG. 1, the rule based flyer approval and distribution system 108 determines whether the flyer is approved based on the approval data. Additionally, in the example of operation of the example system shown in FIG. 1, the rule based flyer approval distribution system 108 provides the flyer to the recipient distribution system 112 if it is determined that the flyer is approved. In the example of operation of the example system shown in FIG. 1, the recipient distribution system 112 determines appropriate flyer recipients of the flyer based on corresponding flyer-to-recipient matching attributes of the flyer recipients and flyer-to-recipient matching attributes of the flyer, and subsequently distributes the flyer to the appropriate flyer recipients.

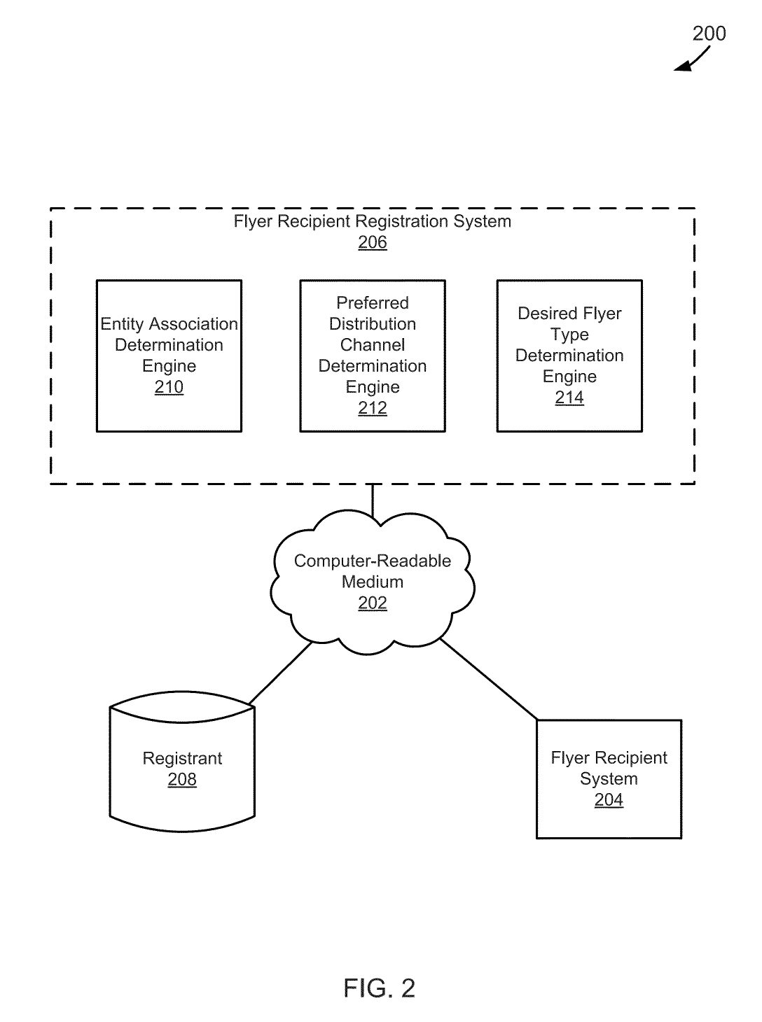

FIG. 2 depicts a diagram 200 of an example of a system for registering a flyer recipient. The example system shown in FIG. 2 includes a computer-readable medium 202, a flyer recipient system 204, a flyer recipient registration system 206, and a registrant datastore 208. In the example system shown in FIG. 2, the flyer recipient system 204, the flyer recipient registration system 206, and the registrant datastore 208 are coupled to each other through the computer-readable medium 202.

In a specific implementation, the flyer recipient system 204 functions according to an applicable system for allowing a flyer recipient to receive and send data, such as the flyer recipient systems described in this paper. The flyer recipient system 204 can allow a flyer recipient to communicate data to the flyer recipient registration system. In one example, data sent by the flyer recipient system 204 to the flyer recipient registration system is used to generate registrant data.

In a specific implementation, the flyer recipient registration system 206 functions according to an applicable system for registering a recipient for receiving flyers, such as the flyer recipient registration systems described in this paper. In registering a recipient, the flyer recipient registration system 206 can generate registrant data. The flyer recipient registration system 206 can generate registrant data from data received from the flyer recipient system 204. In one example, the flyer recipient registration system 206 receives data from the flyer recipient system 204 that is generated by a flyer recipient.

In a specific implementation, the registrant datastore 208 functions to store registrant data of a flyer recipient. Registrant data stored in the registrant datastore 208 can include the identification of a flyer recipient. Registrant data stored in the registrant datastore 208 can also include flyer-to-recipient matching attributes used to associate an entity with a flyer recipient. For example, if the flyer recipient has a child who attends a school, then the registrant data can include the identification of the school and/or school district of the school. Additionally, the registrant data can include the contact information of a flyer recipient. For example, the registrant data can include the email address, or a telephone number of the flyer recipient. Furthermore, the registrant data can include flyer reception channel indicators for the flyer recipient. For example, if the flyer recipient prefers to receive and access flyers through email, then the registrant data can indicate that email is the preferred distribution channel. In another example, if the flyer recipient prefers to access flyers through a webpage and receive emails notifying the flyer recipient that flyers have been distributed to them, then the registrant data can indicate that the flyer recipient prefers to access flyers through a webpage and receive email notifications. The registrant data can also include types of flyers that the flyer recipient wants to receive and types of flyers that the flyer recipient does not want to receive. For example, if the flyer recipient does not want to receive flyers about after school programs, then the registrant data can specify that the flyer recipient does not want to receive flyers about after school programs.

In the example system shown in FIG. 2, the flyer recipient registration system 206 includes an entity association determination engine 210, a preferred distribution channel determination engine 212, and a desired flyer type determination engine 214. In a specific implementation, the entity associated determination engine 210 functions to determine an entity that is associated with a flyer recipient. Depending upon implementation-specific or other considerations, the entity associated determination engine 210 can associate an entity of a plurality of entities with a flyer recipient based on flyer-to-recipient matching attributes of flyer recipients with flyer-to-recipient matching attributes of entities. An entity associated with a flyer recipient, as is determined by the entity association determination engine 210, can be included as part of registrant data stored in the registrant datastore 208. An entity can include an organization or association that approves and distributes electronic versions of flyers. For example, an entity can be a school that children of a flyer recipient attend. The entity association determination engine 210 can determine an entity that is associated with a flyer recipient based on data receive from the flyer recipient through the flyer recipient system 204. For example, a flyer recipient can specify entities the flyer recipient is associated with in data that is sent from the flyer recipient system 204 to the flyer recipient registration system 206.

In a specific implementation, the preferred distribution channel determination engine 212 functions to determine a preferred distribution channel for a flyer recipient. In a specific implementation, the preferred distribution channel determination engine 212 can determine a preferred distribution channel for a flyer recipient based on flyer recipient channel indicators for a flyer recipient. Flyer recipient channel indicators for a flyer recipient used to determine a preferred distribution channel by the preferred distribution channel determination engine 212, can be included as part of registrant data stored in the registrant datastore 208. The preferred distribution channel determination engine 212 can determine a preferred distribution channel of a flyer recipient based on data received from the flyer recipient through the flyer recipient system 204. For example, a flyer recipient can specify preferred distribution channels for the flyer recipient in data that is sent from the flyer recipient system 204 to the flyer recipient registration system 206.

In a specific implementation, the desired flyer type determination engine 214 functions to determine flyer types of flyers that a flyer recipient wishes to receive. Flyer types of flyers that a flyer recipient wishes to receive can be included as part of registrant data stored in the registrant datastore 208. The desired flyer type determination engine 214 can determine flyer types of flyers that a flyer recipient wishes to receive based on data received from the flyer recipient through the flyer recipient system 204. For example, a flyer recipient can specify flyer types of flyers that the flyer recipient wishes to receive in data that is sent from the flyer recipient system 204 to the flyer recipient registration system 206.

In a specific implementation, the desired flyer type determination engine 214 functions to determine flyer type of flyers that a flyer recipient does not wish to receive. Flyer types of flyers that a flyer recipient does not wish to receive can be included as part of registrant data stored in the registrant datastore 208. The desired flyer type determination engine 214 can determine flyer types of flyers that a flyer recipient does not wish to receive based on data received from the flyer recipient through the flyer recipient system 204. For example, a flyer recipient can specify flyer types of flyers that the flyer recipient does not wish to receive in data that is sent from the flyer recipient system 204 to the flyer recipient registration system 206.

In an example of operation of the example system shown in FIG. 2, the flyer recipient system 204 functions to allow a user to send data to the flyer recipient registration system 206. Further in the example of operation of the example system shown in FIG. 2, the flyer recipient registration system 206 functions to generate registrant data. Additionally in the example of operation of the example system shown in FIG. 2, the registrant datastore functions to store registrant data generated by the flyer recipient registration system.

In the example of operation of the example system shown in FIG. 2, the entity associated determination engine 210 determines entities associated with a flyer recipient based on data received from the flyer recipient system 204. In the example of operation of the example system shown in FIG. 2, the preferred distribution channel determination engine 212 determines preferred distribution channels of a flyer recipient based on data received from the flyer recipient system 204. Also in the example of operation of the example system shown in FIG. 2, the desired flyer type determination engine 214 determines flyer types of flyers that a flyer recipient wishes to receive and flyer types of flyer that the flyer recipient does not wish to receive, based on data received from the flyer recipient system 204.

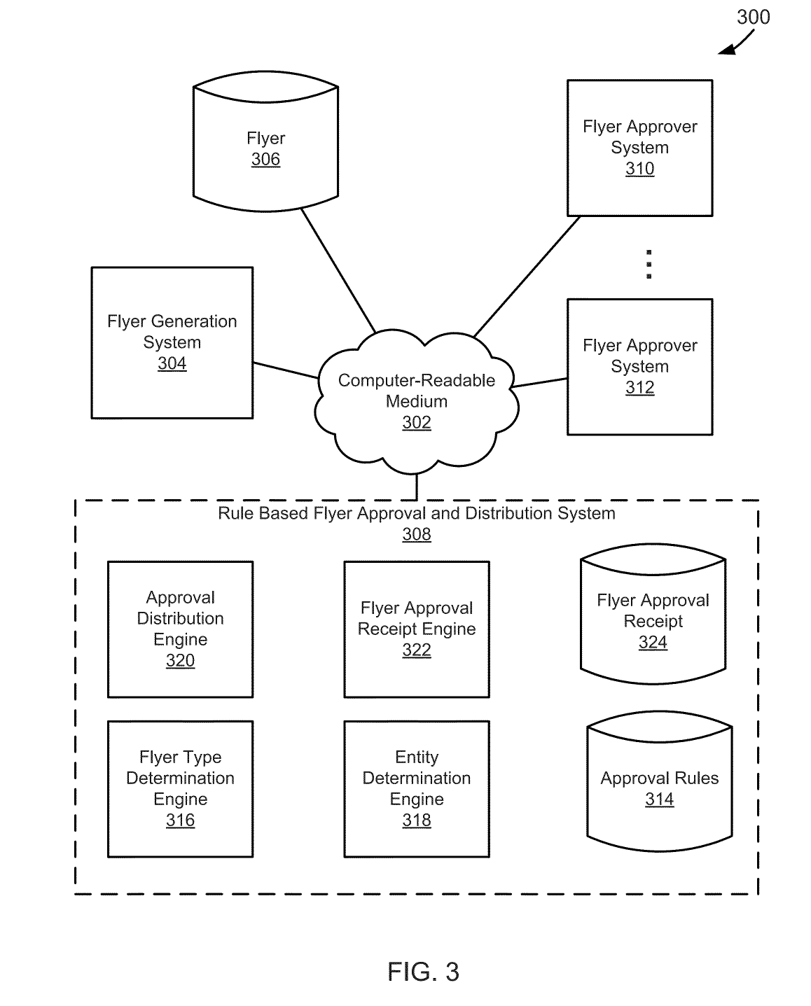

FIG. 3 depicts a diagram 300 of an example of a system for gaining approval for a flyer. The example system of FIG. 3 includes a computer-readable medium 302, a flyer generation system 304, a flyer datastore 306, a rule based flyer approval and distribution system, and flyer approver systems 310 and 312. In the example system shown in FIG. 3, the flyer generation system 304, the flyer datastore 306, the rule based flyer approval and distribution system 308, and the flyer approver systems 310 and 312 are coupled to each other through the computer-readable medium 302.

In a specific implementation, the flyer generation system 304 functions to generate flyers. The flyer generation system 304 can be used by a flyer generator to create a flyer. The flyer generation system 304 can be part of or associated with an entity for which a flyer is created. For example, the flyer generation system 304 can be a school within a school district for which a flyer is created. Additionally, the flyer generation system 304 can be not part of an entity for which a flyer is created. For example, the flyer generation system 304 can be a soccer league that is not part of a school, in which students at the school are part of. The flyer generation system 304 can generate a flyer that includes both text and images.

In a specific implementation, the flyer datastore 306 functions to store flyer data. Flyer data stored in the flyer datastore 306 can include flyers for approval and subsequent distribution to flyer recipients. A flyer, as is used in this paper, is an electronic version of a notification that is meant to be distributed. Furthermore, the flyer can be an electronic version of a paper notification, leaflet, pamphlet, or advertisement that is meant to be distributed. Additionally, the flyer can be an electronic version of a paper handbill that is meant to be distributed. For example, the flyer can be an electronic version of a leaflet informing of a school bake sale. In another example, the flyer can be an electronic version of a pamphlet listing time and locations of exercise classes. The flyer can include either or both images and text. The images or text can describe or be associated with an event that is the subject of the flyer.

In a specific implementation, flyers are stored in the flyer datastore 306 as web documents, included as part of flyer data. For example, the flyers can be stored in the flyer datastore 306 as portable document format (hereinafter referred to as “pdf”) documents. The flyers stored in the flyer datastore 306 can also include metadata associated with the flyers. Metadata for flyers can be used to search through flyers stored within the flyer datastore 306 for flyer retrieval, display, and/or distribution. For example, a flyer recipient can search through flyers stored in the flyer datastore 306 using the metadata. Metadata for flyers can also be used to distribute flyers and/or thumbnails of flyers. The metadata can include information about the author, the title, the subject, and the creation and/or update dates of a flyer. Metadata for flyers can also include information about images and/or text in a flyer. For example, the metadata can include information about embedded images in the flyer. Furthermore, the metadata can include information about the entities for which a flyer is created or otherwise associated with the flyer. For example, if the flyer is created for or is associated with a specific school within a school district, then the metadata can identify the specific school for which the flyer is created.

In a specific implementation, the flyer datastore 306 stores flyer data including thumbnails of flyers. A thumbnail can be a reduced size version of a flyer that can be distributed to flyer recipients. For example, the thumbnail can be a reduced size image of a flyer stored in the flyer datastore 306. Further in the example, the thumbnail can have a reduce pixel array size of a flyer stored in the flyer datastore 306. The thumbnail can also include an embedded link or reference to the flyer stored in the flyer datastore 306 for which the thumbnail is created. In an example, the thumbnail can be distributed to a flyer recipient and the flyer recipient can activate the embedded link in the thumbnail to gain access to the flyer in the flyer datastore 306 for which the thumbnail is created.

In a specific implementation, the flyer data 306 stores flyer-to-recipient matching attributes of a flyer, included as part of flyer data for the flyer. Matching attributes of a flyer, included as part of flyer-to-recipient matching attributes, can include characteristics of appropriate recipients of the flyer. For example, matching attributes of a flyer for a youth soccer league can include participants, parents of the participants, or guardians of the participants of the youth soccer league. In another example, matching attributes of a flyer for a school can include parents or guardians of students who attend the school.

In a specific implementation, the rule based flyer approval and distribution system 308 functions according to an applicable system for gaining approval for and distributing flyers, such as the rule based flyer approval and distribution systems described in this paper. Approval for flyers includes the authorization to distribute the flyers to appropriate flyer recipients. The rule based flyer approval and distribution system 308 can gain approval for flyers stored in the flyer datastore 306. The rule based flyer approval and distribution system 308 gains approval for flyer according to one or a plurality of approval rules. Approval rules can specify flyer approvers that need to approve of a flyer before it is distributed to flyer recipients. The rule based flyer approval and distribution system 308 can distribute the flyer or thumbnails of flyers to flyer approvers indicated by approval rules, that need to approve the flyer, in order to gain approval for the flyer.

In a specific implementation, the flyer approver systems 310 and 312 are systems through which flyers approvers receive and send data. The flyer approver systems 310 and 312 can be mobile devices, such as smart phones. The flyer approver systems 310 and 312 can also be thin clients. Additionally, the flyer approver systems 310 and 312 can be ultra-thin clients or zero clients.

In a specific implementation, the flyers are distributed to flyer approvers through the flyer approver systems 310 and 312. Flyers can be distributed to a flyer approver through the flyer approver systems 310 and 312 using the distribution channels described in this paper. The rule-based flyer approval and distribution system 308 can retrieve flyers or thumbnails of flyers from the flyer datastore 306 and distribute the flyers or thumbnails of flyers to flyer approvers by sending the flyer over an applicable distribution channel to the flyer approver systems 310 and 312. As a result of a flyer being distributed to a flyer approver, the flyer approver can view the flyer and determine whether they approve the flyer.

In a specific implementation, flyer approvers communicate whether they approve a flyer through the flyer approver systems 310 and 312. Flyer approvers can send approval data from the flyer approver systems 310 and 312 to the rule based flyer approval and distribution system that indicates that the flyer approvers approve a flyer. Additionally, flyers approvers can send approval data from the flyer approver systems 310 and 312 to the rule based flyer approval and distribution system 308 that indicates that the flyer approver does not approve a flyer.

In the example system shown in FIG. 3, the rule based flyer approval and distribution system 308 includes an approval rules datastore 314, a flyer type determination engine 316, an entity determination engine 318, an approval distribution engine 320, a flyer approval receipt engine 322, and a flyer approval receipt datastore 324. In a specific implementation, the approval rules datastore 314 stores approval rules. Approval rules can include the identification of flyer approvers who need to approve a flyer before the flyer can be distributed to flyer recipients.

In a specific implementation, the approval rules datastore 314 stores approval rules for a specific entity for which a flyer is created or is associated. The approval rules for specific entities stored in the approval rules datastore 314 can differ between entities. For example, approval rules for a first school within a school district can specify that approval is needed from a principal of the first school and the superintendent of the school district of the first school. Further in the example, approval rules for a second school within a school district can differ from approval rules for a first school within the school district by specifying that approval for a flyer is only needed from a principal of the second school and not from the superintendent of the school district.

In a specific implementation, the approval rule datastore 314 stores approval rules for a specific flyer type for a specific entity for which a flyer is created or is associated. The approval rules for a specific entity can be different for different flyer types. For example, approval rules for a flyer of type A for a school can specify that approval is needed by both a principal of the school and a superintended of the school district of the first school. Further in the example, approval rules for a flyer of type B for the school can differ from approval rules for a flyer of type A by specifying that approval is only needed for the principal of the school for flyers of type B.

In a specific implementation, the approval rule datastore 314 stores approval rules that are part of an approval hierarchy. The approval hierarchy can indicate what flyer approvers need to approve a flyer in accordance with an approval hierarchy. The approval hierarchy can indicate an order in which a flyer needs to be approved by flyer approvers. For example, an approval hierarchy can indicate that approval is needed from a first flyer approver and after the first flyer approver approves the flyer, and that approval is needed from second and third flyer approvers after the first flyer approver approves the flyer. Additionally, an approval hierarchy can include conditions that change the approval hierarchy based on which flyer approvers approve the flyer. For example, the approval hierarchy can indicate that approval from a second flyer approver is needed if a first flyer approver approves a flyer but that approval from a third flyer approver is needed if the first flyer approver does not approve the flyer.

In a specific implementation, the flyer type determination engine 316 functions to determine a flyer type of a flyer stored in the flyer datastore 306. The flyer type determination engine 316 can determine a flyer type of a flyer based on content of the flyer. The flyer type determination engine 316 can also determine a flyer type of a flyer based on metadata for the flyer. Specifically, the flyer type determination engine 316 can determine a flyer type of a flyer based on metadata for the flyer that indicates the creator of the flyer. For example, if a soccer coach creates a flyer, then the flyer type determination engine 316 can determine that the flyer is related to a soccer league based on the identification of the soccer coach who created the flyer. The flyer type determination engine 316 can also determine a flyer type of a flyer based on metadata that indicates the flyer type of the flyer. For example, a parent teacher association can create a flyer for a bake sale and create metadata that indicates that the flyer is of a type for school activities.

In a specific implementation, the entity determination engine 318 functions to determine an entity for which a flyer stored in the flyer datastore 306 is created or is otherwise associated. The entity determination engine 318 can determine an entity that a flyer is created for or is associated with based on the content of the flyer. The entity determination engine 318 can also determine an entity that a flyer is created for or is associated with based on the metadata for the flyer. For example, if a principal at a school creates a flyer, as indicated by metadata for the flyer, the entity determination engine 318 can determine that the flyer is create for or is associated with the school.

In a specific implementation, the approval distribution engine 320 functions to receive flyer data. In receiving flyer data, the approval distribution engine 316 can store received flyer data in the flyer datastore 306. Depending upon implementation-specific or other considerations, the approval distribution engine 320 can receive flyer data for an applicable system for generating flyer data, such as the flyer generation systems described in this paper.

In a specific implementation, the approval distribution engine 320 functions to determine which flyer approvers to distribute a flyer to in order to gain approval for the flyer. The distribution engine can use a flyer type of a flyer, as is determined by the flyer type determination engine 316 to determine approval rules, stored in the approval rules datastore 314, that indicate flyer approvers to distribute the flyer to in order to gain approval for the flyer. The approval distribution engine 320 can also use an entity that the flyer is created for or is associated with, as is determined by the entity determination engine 318, to determine approval rules, stored in the approval rules datastore 314, that indicate flyer approvers to distribute the flyer to in order to gain approval for the flyer. Additionally, the approval distribution engine 320 can use a combination of both a flyer type of a flyer, determined by the flyer type determination engine 316, and an associated with the flyer, as is determined by the entity determination engine 318, to determine approval rules, stored in the approval rules datastore 314, that indicate flyer approvers to distribute the flyer to in order to gain approval for the flyer.

In a specific implementation, the approval distribution engine 320 functions to distribute a flyer stored in the flyer datastore 306 to flyer approvers to gain approval for the flyer. The approval distribution engine 320 can distribute a flyer to flyer approvers indicated by approval rules and/or an approval hierarchy and associated approval conditions of the flyer. In distributing a flyer to flyer approvers, the approval distribution engine 320 can determine flyer approvers to send the flyer to using approval rules and/or an approval hierarchy and associated approval conditions of the flyer. In distributing a flyer, the approval distribution engine 320 can distribute the flyer or a thumbnail of a flyer over an applicable distribution channel to a flyer approval system (e.g. 310) that is used by a flyer approver whose approval is needed for the flyer.

In a specific implementation, the flyer approval receipt engine 322 functions to receive approval data from flyer approvers. The approval data indicates whether a flyer approver approves a flyer. The flyer approval receipt engine 322 can receive approval data from a flyer approver system (e.g. 310) that a flyer approver uses. In one example, the flyer approver data includes the identification of a flyer that is approved and an identification of the flyer approver who approved the flyer.

In a specific implementation, the flyer approval receipt datastore 324 functions to store approval data for a flyer. The flyer approval receipt datastore 324 can store approval data for a flyer that is received by the flyer approval receipt engine 322. Additionally, the flyer approval receipt datastore 324 can store approval data that identifies a flyer that is approved and a flyer approver who approved the flyer. Furthermore, the flyer approval receipt datastore 324 can store all approval data received for a specific flyer together in a specific datastructure for the specific flyer.

In an example of operation of the example system shown in FIG. 3, the flyer generation system generates flyers that are stored in the flyer datastore 306. Further in the example of operation of the example system shown in FIG. 3, the flyer type determination engine 316 determines a flyer type of a flyer stored in the flyer datastore 306. In the example of operation of the example system shown in FIG. 3, the entity determination engine 318 determines an entity that a flyer in the flyer datastore 306 is created for or is associated.

In the example of operation of the example system shown in FIG. 3, the approval rules datastore stores approval rules that indicate what flyer approvers need to approve a flyer of a specific type for an entity before the flyer can be distributed to flyer recipients. Further in the example of operation of the example system shown in FIG. 3, the approval distribution engine 320 determines which flyer approvers to distribute a flyer for approval to based on a flyer type of the flyer, determined by the flyer type determination engine 316, the entity associated with the flyer, determined by the entity determination engine 318, and approval rules stored in the approval rules datastore 314. The approval distribution engine 320 distributes a flyer to appropriate flyer approvers over a distribution channel through a flyer approver systems 310 and 312 used by the appropriate flyer approvers. Also in the example of operation of the example system shown in FIG. 3, the flyer approval receipt engine 322 receives approval data that indicates whether a flyer approver approves a flyer from a flyer approver system (e.g. 310). The flyer approval receipt datastore 324, in the example of operation of the example system shown in FIG. 3, stores approval data received by the flyer approval receipt engine 322.

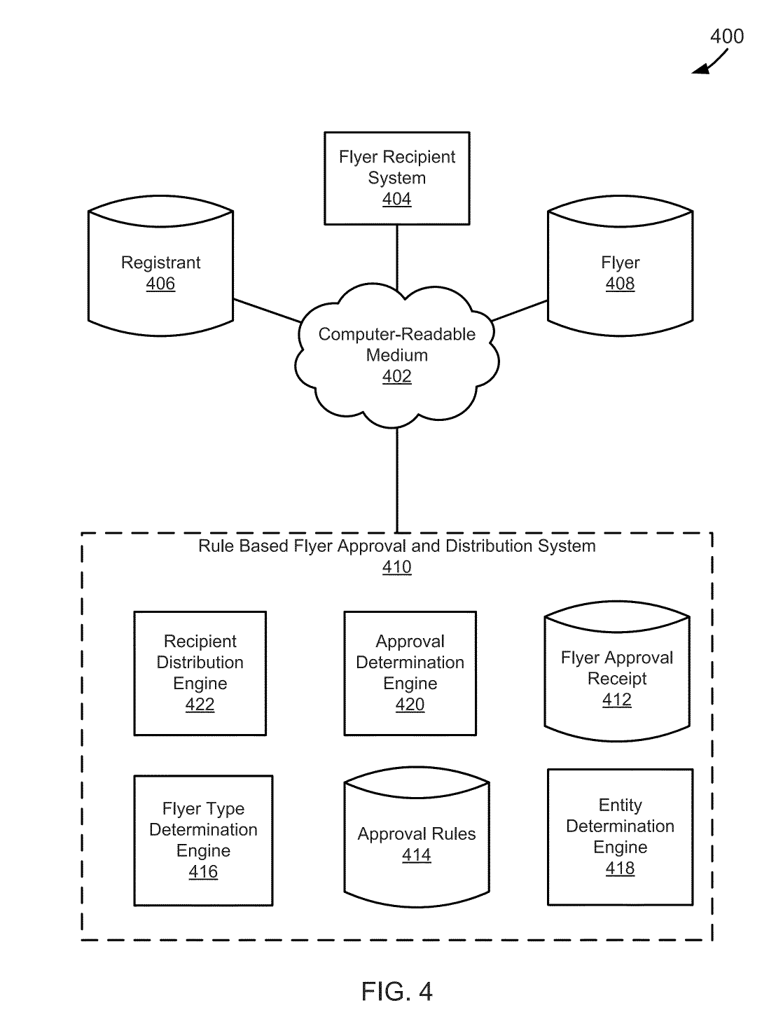

FIG. 4 depicts a diagram 400 of an example of a system for determining whether approval to distribute a flyer exists and distributing the flyer if approval does exist. The example system of FIG. 4 includes a computer-readable medium 402, a flyer recipient system 404, a registrant datastore 406, a flyer datastore 408, and a rule based flyer approval and distribution system 410. In the example system shown in FIG. 4, the flyer recipient system 404, the registrant datastore 406, the flyer datastore 408, and the rules based flyer approval and distribution system 410 are coupled to each other through the computer-readable medium 402.

In a specific implementation, the flyer recipient system 404 functions according to an applicable system for sending and receiving data through which a flyer recipient is distributed a flyer, such as the flyer recipient systems described in this paper. The flyer recipient system 404 can allow a flyer recipient to view a flyer that is distributed to the flyer recipient over an applicable distribution channel, such as the distribution channels described in this paper.

In a specific implementation, the registrant datastore 406 function according to an applicable datastore for storing registrant data, such as the registrant datastores described in this paper. The registrant datastore 406 can store registrant data for a flyer recipient that is received from a flyer recipient system 404 used by the flyer recipient. The registrant data can include any applicable information related to a flyer recipient, such as the data included as part of the registrant data described throughout this paper.

In a specific implementation, the flyer datastore 408 functions according to an applicable datastore for storing flyers, such as the flyer datastores described in this paper. The flyer datastore 408 can also store thumbnails of flyers stored in the flyer datastore 408. Additionally, the flyer datastore 408 can store metadata of flyers stored in the flyer datastore 408.

In a specific implementation, the rule based flyer approval and distribution system 410 can function according to an applicable system for gaining approval for a flyer and distributing the flyer, such as the rule based flyer approval and distribution systems described in this paper. The rule based flyer approval and distribution system can gain approval for flyers stored in the flyer datastore 408. Additionally, the rule based flyer approval and distribution system can distribute flyers stored in the flyer datastore 408 once approval for the flyers is gained.

The rule based flyer approval and distribution system 410 includes a flyer approval receipt datastore 412, an approval rules datastore 414, a flyer type determination engine 416, an entity determination engine 418, an approval determination engine 412, and a recipient distribution engine 422. In a specific implementation, the flyer approval receipt datastore 412 functions according to an applicable datastore for storing approval data, such as the flyer receipt approval receipt datastores described in this paper. The flyer approval receipt data 412 can store approval data that indicates whether flyer approvers have approved a flyer stored in the flyer datastore 408. Approval data stored in the flyer approval receipt datastore 412 can identify whether approval for a flyer exists for a specific flyer approver, and the identification of the specific flyer approver.

In a specific implementation, the approval rules datastore 414 functions according to an applicable datastore for storing approval rules, such as the approval rules datastores described in this paper. Approval rules stored in the approval rules datastore 414 can indicate the flyer approvers whose approval is necessary before a flyer stored in the flyer datastore 408 can be distributed.

In a specific implementation, the flyer type determination engine 416 functions according to an applicable system for determining a flyer type of a flyer, such as the flyer type determination engines described in this paper. The flyer type determination engine 416 can determine a flyer type of a flyer stored in the flyer datastore 408.

In a specific implementation, the entity determination engine 418 functions according to an applicable system for determining an entity associated with a flyer, such as the entity determination engines described in this paper. The entity determination engine 418 can determine an entity of which a flyer in the flyer datastore 408 is associated. The entity determination engine 418 can also determine an entity for which a flyer in the flyer datastore 408 is created.

In a specific implementation, the approval determination engine 420 functions to determine whether a flyer has necessary approval to be distributed. In determining whether a flyer has approval to be distributed, the approval determination engine 420 can use the flyer type of the flyer, as determined by the flyer type determination engine 416, and the entity associated with the flyer, as determined by the entity determination engine 418, to determine approval rules, stored in the approval rules datastore 414, for the flyer. Approval rules for a flyer, as determined by the approval determination engine 420, can indicate flyer approvers that need to approve the flyer before it can be distributed. Based on approval rules for a flyer, the approval determination engine 420 can determine whether necessary approval exists to distribute the flyer from approval data stored in the flyer approval receipt datastore 412. For example, if the approval determination engine 420 determines that first, second, and third flyer approvers need to approve a flyer before it can be distributed, and approval data in the flyer approval receipt datastore 412 indicates that the first, second, and third flyer approver have approved the flyer, then the approval determination engine 420 can determine that necessary approval exists to distribute the flyer. The approval determination engine 420 can generate distribution instructions based on whether it is determined that necessary approval exists to distribute a flyer. Distribution instructions can specify whether or not to distribute a flyer.

In a specific implementation, the recipient distribution engine 422 functions to distribute a flyer to flyer recipients. The recipient distribution engine 422 can distribute a flyer stored in the flyer datastore 408 based on whether the approval determination engine 420 determines that necessary approval to distribute the flyer exists. Specifically, the recipient distribution engine 422 can distribute a flyer based on distribution instructions received from the approval determination engine 420 that indicate whether to distribute the flyer. Depending upon implementation-specific or other considerations, the recipient distribution engine 422 can distribute a flyer to a flyer recipient directly, or provide the flyer to an applicable system for distributing the flyer to the flyer recipient.

In a specific implementation, the recipient distribution engine 422 can distribute a flyer to a flyer recipient through the flyer recipient system 404 based on registrant data stored in the registrant datastore 406. In distributing a flyer to a recipient, the recipient distribution engine 422 can make the flyer available to flyer recipients that share flyer-to-recipient matching attributes with the flyer-to-recipient matching attributes included as part of flyer data of flyers. For example, the recipient distribution engine 422 can determined whether a flyer recipient is associated with an entity that is associated with a flyer that is approved for distribution, and is therefore an appropriate flyer recipient. Additionally, the recipient distribution engine 422 can distribute a flyer to a flyer recipient over a preferred distribution channel of the flyer recipient, as indicated by registrant data stored in the registrant datastore 406. Additionally, the recipient distribution engine 422 can determine whether to distribute a flyer to a flyer recipient based on registrant data stored in the registrant datastore 406 and a flyer type of the flyer, as determined by the flyer type determination engine 416. For example, if the registrant data indicates that a flyer recipient does not want receive flyers of a specific flyer type, and the flyer type determination engine 416 determines that a flyer for distribution to the flyer recipient is of the specific flyer type, then the recipient distribution engine 422 does not distribute the flyer to the flyer recipient.

In an example of operation of the example system shown in FIG. 4, the flyer recipient system 404 sends and receives data related to distribution of a flyer to a flyer recipient who uses the flyer recipient system 404. Also in the example of operation of the example system shown in FIG. 4, the registrant datastore stores registrant data received from the flyer recipient system 404. Further in the example of operation, the flyer datastore 408 stores flyers.

In the example of operation of the example system shown in FIG. 4, the flyer approval receipt datastore 412 stores approval data for flyers that is received from flyer approvers for the flyers. Additionally, in the example of operation, the approval rules datastore 414 stores approval rules that indicate flyer approvers that need to approve a flyer before it can be distributed. In the example of operation, the flyer type determination engine 416 determines a flyer type of a flyer stored in the flyer datastore 408. Still further in the example of operation, the entity determination engine 418 determines an entity associated with a flyer stored in the flyer datastore 408. Also in the example of operation, the approval determination engine 420 determines whether necessary approval exists to distribute a flyer based on determined approval rules stored in the approval rules datastore that apply to the flyer and approval data for the flyer stored in the flyer approval receipt datastore 412. The recipient distribution engine 422, in the example of operation, distributes a flyer that has necessary approval, as is determined by the approval determination engine 420, according to registrant data of a flyer recipient to the flyer recipient.

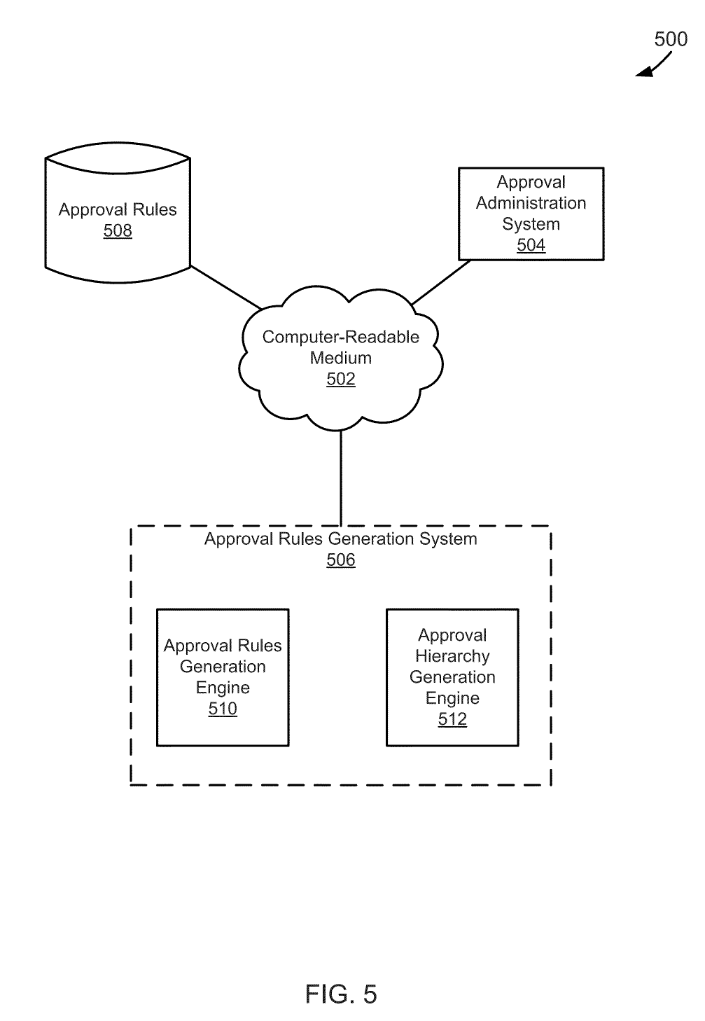

FIG. 5 depicts a diagram 500 of an example of a system for generating approval rules and approval hierarchies. The example system of FIG. 5 includes a computer-readable medium 502, an approval administration system 504, an approval rules generation system, and an approval rules datastore 508. In the example system shown in FIG. 5, the approval administration system 504, the approval rules generation system 506, and the approval rules datastore 508 are coupled to each other through the computer-readable medium 502.

In a specific implementation, the approval administration system 504 functions as a system through which an approval administration can send and receive data related to the approval of flyers. An approval administration can be an individual or an entity that can make decisions regarding the appointing and approving of flyer approvers, approval rules, approval hierarchies, and associated approval hierarchy conditions. Additionally, an approval administration can be an individual or an entity that can make an approval hierarchy and/or conditions associated with an approval hierarchy. For example, the approval administration system 504 can be the board of a school district. In another example, the approval administration system 504 is the board of a parent teacher association. The approval administration can be comprised of a plurality of people in various group or organizations who can appoint and approve flyer approvers. The approval administration system can send data to the approval rules generation system 506 that is used to generate approval rules and/or associated approval hierarchies.

In a specific implementation, the approval rules generation system 506 functions to generate approval rules and associated approval hierarchies to approval rules. The approval rules generation system 506 can generate approval rules and associated approval hierarchy based on data received from the approval administration system 504. In one example, the approval rules generation system 506 generates approval rules and/or approval hierarchies and associated approval hierarchy conditions specific to an entity. In another example, the approval rules generation system 506 generates approval rules and/or approval hierarchies and associated approval hierarchy conditions specific to a flyer type of a flyer. Additionally, the approval rules generation system 506 can generate approval rules and/or approval hierarchies and associated approval hierarchy conditions specific to a flyer type of a flyer for a specific entity.

In a specific implementation, the approval rules datastore 508 functions according to an applicable datastore for storing approval rules, such as the approval rules datastore described in this paper. The approval rules datastore 508 can store approval rules that are generated by the approval rules generation system 506. Approval rules stored by the approval rules datastore 508 can be used to gain approval to distribute flyers to flyer recipients. Additionally the approval rules datastore 508 can store approval rules hierarchies and conditions associated with approval rules hierarchies.

In the example system of FIG. 5, the approval rules generation system 506 includes an approval rules generation engine 510 and an approval hierarchy generation engine 512. In a specific implementation, the approval rules generation engine 510 generates approval rules. The approval rules generation engine 510 can generate approval rules based on data received from the approval administration system 504. Approval rules generated by the approval rules generation engine 510 can be specific to flyer types of flyers. For example, the approval rules generation engine 510 can generate rules that specify flyer approvers that need to approve a flyer of a specific type, in order for the flyer to be approved for distribution. Additionally, approval rules generated by the approval rules generation engine 510 can be specific to an entity associated with a flyer. For example, the approval rules generation engine 510 can generate rules that specify flyer approvers that need to approve a flyer associated with an entity, in order for the flyer to be approved for distribution. Furthermore, approval rules generated by the approval rules generation engine 510 can be specific to a flyer type for a specific entity. For example, the approval rules generation engine 510 can generate rules that specify flyer approvers that need to approve a flyer of a specific flyer type that is associated with a specific entity, in order for the flyer to be approved for distribution.

In a specific implementation, the approval hierarchy generation engine 512 functions to generate an approval hierarchy and associated approval hierarchy conditions. The approval hierarchy generation engine 512 can generate approval hierarchies and associated approval hierarchy conditions based on data received from the approval administration system 504. Approval hierarchies and associated approval hierarchy conditions generated by the approval hierarchy generation engine 512 can be specific to flyer types of flyers. For example, the approval hierarchy generation engine 512 can generate approval hierarchies and associated approval hierarchy conditions that are followed to approve a flyer of a specific type for distribution. Additionally, approval hierarchies and associated approval hierarchy conditions generated by the approval hierarchy generation engine 512 can be specific to an entity associated with a flyer. For example, the approval hierarchy generation engine 512 can generate approval hierarchies and associated approval hierarchy conditions that are followed to approve a flyer associated with an entity for distribution. Furthermore, approval hierarchies and associated approval hierarchy conditions generated by the approval hierarchy generation engine 512 can be specific to a flyer type for a specific entity. For example, the approval hierarchy generation engine 512 can generate approval hierarchies and associated approval hierarchy conditions that are followed to approve a flyer of a specific flyer type that is associated with a specific entity for distribution.

In an example of operation of the example system shown in FIG. 5, the approval administration system sends and receives data related to the approval of flyers. Further in the example of operation, the approval rules generation engine 510 can generate approval rules based on data received from the approval administration system 504. Additionally, in the example of operation, the approval hierarchy generation engine 512 generates approval hierarchies and conditions associated with approval hierarchies based on data received from the approval administration system 504. The approval rules datastore 508, in the example of operation stores approval rules generated by the approval rules generation engine 510 and approval hierarchies and associated approval hierarchy conditions generated by the approval hierarchy generation engine 512.

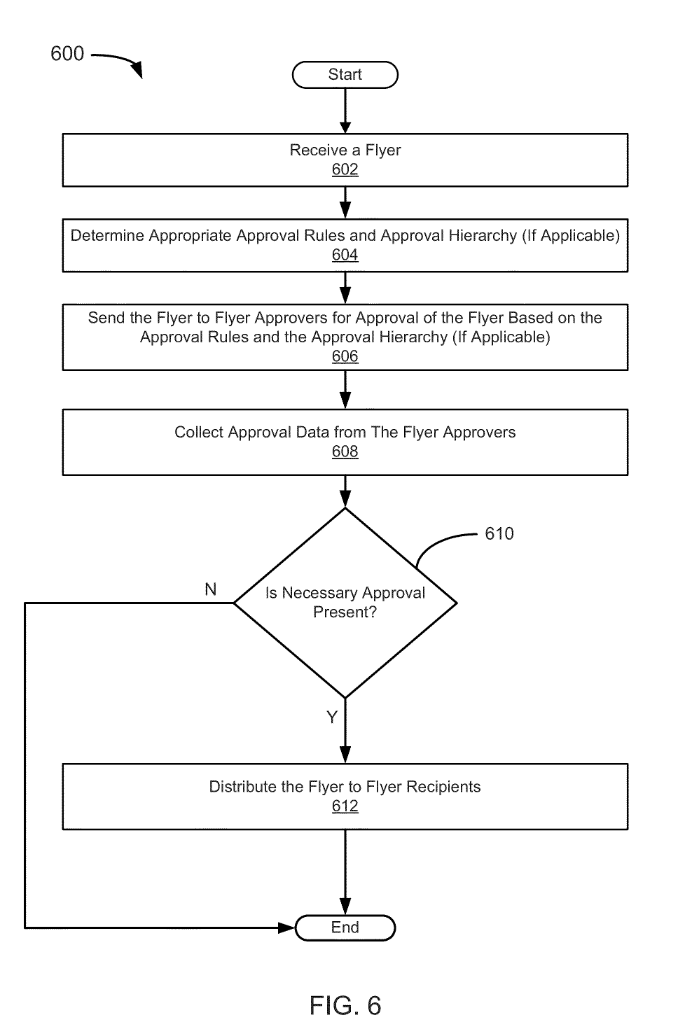

FIG. 6 depicts a flowchart 600 of an example of a method for gaining approval to distribute a flyer and distributing the flyer. The example flowchart 600 begins at module 602 with receive a flyer. Content of a flyer received at module 602 can include both images and text. The flyer received at module 602 can be received from a flyer generation system.

In the example flowchart 600, after module 602, the flowchart 600 continues to module 604 where appropriate approval rules and an approval hierarchy (if applicable) are determined. The appropriate approval rules are approval rules that indicate flyer recipients that need to approve the flyer before it can be distributed to flyer recipients. In the example flowchart 600, the approval hierarchy is applicable, as not every flyer has an approval hierarchy that is followed in order to gain approval for the flyer. At module 604, the appropriate approval rules and a rules hierarchy, if applicable, can be determined based on a flyer type of the flyer received at module 602. Additionally, in the example flowchart 600 at module 604, the appropriate approval rules and a rules hierarchy, if applicable, can be determined based on an entity associated with the flyer received at module 602. Furthermore, in the example flowchart 600 at module 604, the appropriate approval rules and a rules hierarchy, if applicable, can be determined based on a flyer type of the flyer and an entity associate with the flyer.

In the example flowchart 600, after module 604, the flowchart continues to module 608, where the flyer is sent to flyer approvers for approval of the flyers based on the approval rules and rules hierarchy, if applicable, determined at module 604. In the example flowchart 600, appropriate flyer approvers to send the flyer to for approval can be determined from approval rules determined at module 604. Additionally, if applicable, in the example flowchart 600, the flyer can be sent to appropriate flyer approvers in accordance with an approval hierarchy determined at module 604.

In the example flowchart 600, after module 606, the flowchart continues to module 608 where approval data is collected for the flyer from the flyer approvers. In the example flowchart 600, the approval data is collected from the flyers approves that the flyer was sent to at module 606. The approval data can indicate whether the flyer is approved by the flyer approvers. The approval data can also identify the flyer approver who either approved or denied approval of the flyer.

In the example flowchart 600, after module 608, the flowchart continues to decision point 610 where it is determined whether necessary approval to distribute the flyer exists. In the example flowchart 600, at decision point 610, whether necessary approval to distribute the flyer exists can be determined based on approval rules determined at module 604. Further in the example flowchart 600, at decision point 610, whether necessary approval to distribute the flyer exists can be determined, if applicable, based on an approval hierarchy determined at module 604.

In the example flowchart 600, if it is determined at decision point 610 that necessary approval does not exist to distribute the flyer, then the flowchart ends. If it is determined at decision point 610 that necessary approval does exists to distribute the flyer, then the example flowchart continues to module 612. At module 612, the flyer is distributed to flyer recipients. The flyer can be distributed to flyer recipients, at module 612, in accordance with registrant data used to determine a preferred distribution channel in which to distribute the flyer to the flyer recipient.

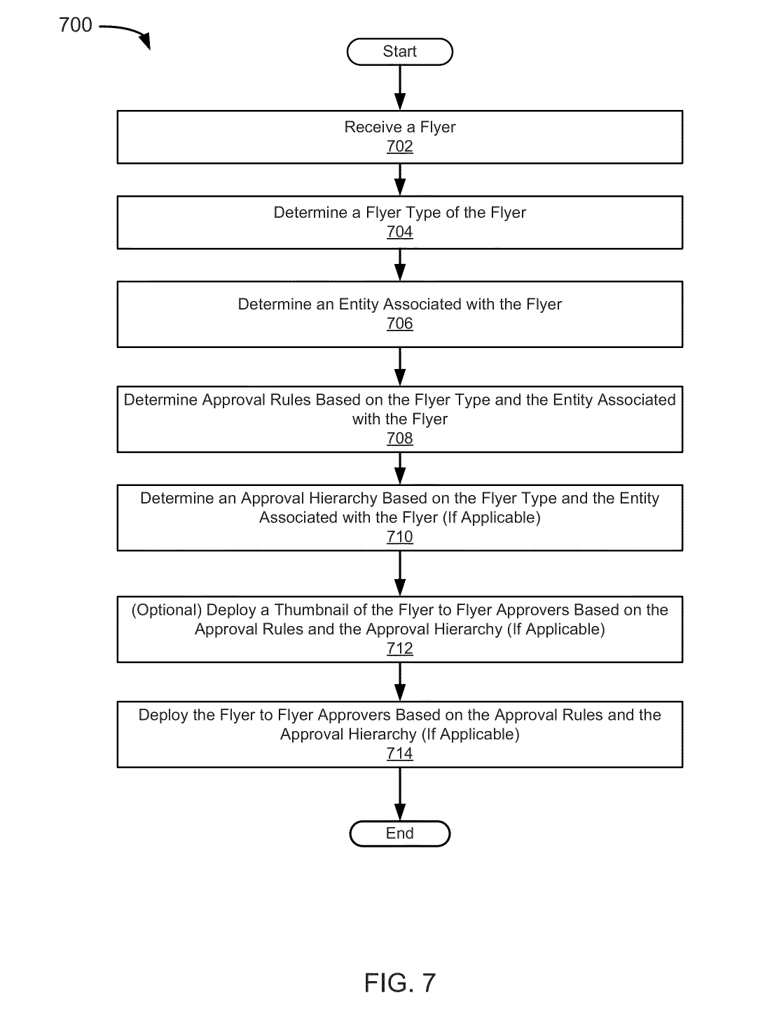

FIG. 7 depicts a flowchart 700 of an example of a method for sending a flyer to flyer approvers to gain approval to distribute the flyer. The example flowchart 700 begins at module 702 where a flyer is received. Content of a flyer received at module 702 can include both images and text. The flyer received at module 702 can be received from a flyer generation system.

The example flowchart 700 continues to module 704 where a flyer type of the flyer received at module 702 is determined. In the example flowchart 700, a flyer type of the flyer can be determined by a flyer type determination engine. A flyer type can be determined based on metadata for the flyer.

The example flowchart 700 continues to module 706, where an entity associated with the flyer received at module 702 is determined. In the example flowchart 700, an entity associated with the flyer can be determined by an entity determination engine. An entity associated with the flyer can be determined based on metadata for the flyer.

The example flowchart 700 continues to module 708, where approval rules are determined based on the flyer type of the flyer, determined at module 704, and an entity associated with the flyer, determined at module 706. In the example flowchart 700, the approval rules can be determined by a distribution engine. The approval rules can indicate flyer approvers to send the flyer to for approval.

The example flowchart 700 continues to module 710, where, if applicable, an approval hierarchy is determined based on the flyer type of the flyer, determined at module 704, and an entity associated with the flyer, determined at module 706. In the example flowchart 700, the approval hierarchy can be determined by a distribution engine. In the example flowchart 700, determining an approval hierarchy is applicable only if an approval hierarchy exists for approving the flyer received at module 702.

The example flowchart 700 optionally continues to module 712, where a thumbnail of the flyer is deployed to flyer approvers according to the approval rules determined at module 708 and the approval hierarchy, if applicable, determined at module 710. The thumbnail of the flyer deployed to flyer approvers can include a link through which a flyer approver can access the flyer or have the flyer deployed to them.

The example flowchart 700 continues to module 714, where the flyer is deployed to the flyer approvers based on according to the approval rules determined at module 708 and the approval hierarchy, if applicable, determined at module 710. The flyer can be deployed to the flyer approvers through the various distribution channels discussed in this paper.

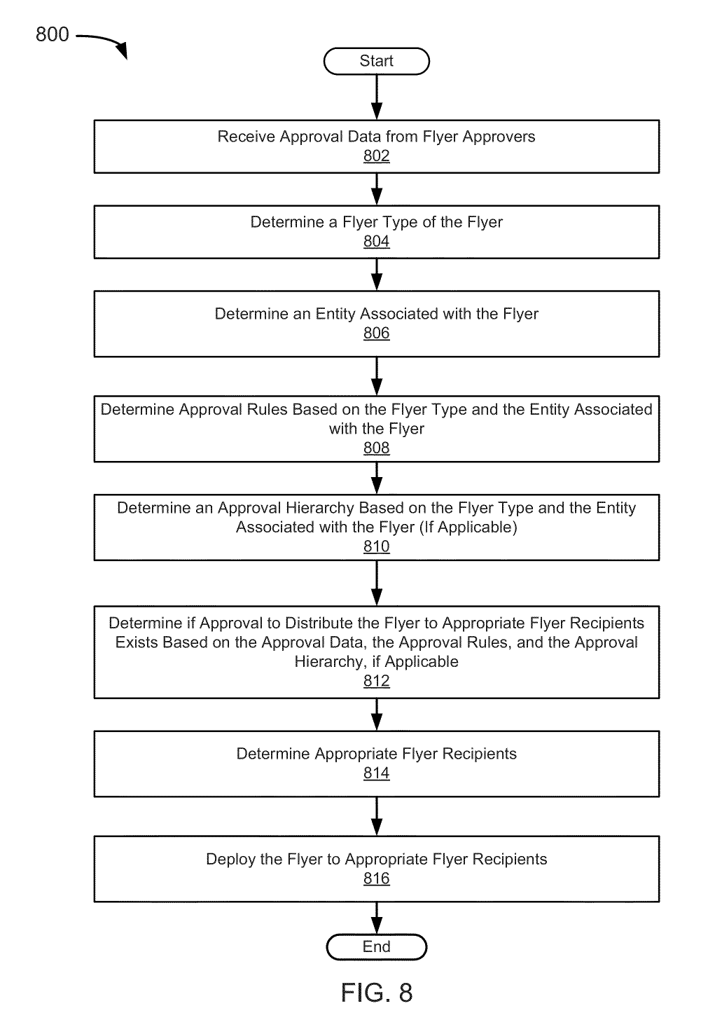

FIG. 8 depicts a flowchart 800 of an example of a method for determining whether approval exists to distribute a flyer to an appropriate flyer recipient exists and distributing the flyer to the appropriate flyer recipient. The example flowchart 800 begins at module 802 approval data is received for a flyer from flyer approvers. The approval data can include whether a flyer is approved. The approval data can also include the identification of the flyer approvers who either approved or did not approve of a flyer.

The example flowchart 800 continues to module 804 where a flyer type of a flyer is determined. In the example flowchart 800, a flyer type of the flyer can be determined by a flyer type determination engine. A flyer type can be determined based on metadata for the flyer.

The example flowchart 800 continues to module 806, where an entity associated with a flyer is determined. In the example flowchart 800, an entity associated with the flyer can be determined by an entity determination engine. An entity associated with the flyer can be determined based on metadata for the flyer.

The example flowchart 800 continues to module 808, where approval rules are determined based on the flyer type of the flyer, determined at module 804, and an entity associated with the flyer, determined at module 806. In the example flowchart 800, the approval rules can be determined by a distribution engine. The approval rules can indicate the flyer approvers that need to approve the flyer.

The example flowchart 800 continues to module 810, where, if applicable, an approval hierarchy is determined based on the flyer type of the flyer, determined at module 804, and an entity associated with the flyer, determined at module 806. In the example flowchart 800, the approval hierarchy can be determined by a distribution engine. In the example flowchart 800, determining an approval hierarchy is applicable only if an approval hierarchy exists for approving the flyer.

The example flowchart 800 continues to module 812, where it is determined if approval exists to distribute the flyer to appropriate flyer recipients based on the approval data received at module 802, the approval rules determined at module 808, and the approval hierarchy, if applicable, determined at module 810. For example, the approval rules can indicate that first and second flyer approvers need to approve the flyer before it can be distributed to appropriate flyer recipients. Further in the example, the approval data received at module 802 can indicate that only the first flyer approver approved distribution of the flyer. Therefore, it can be determined that the flyer does not have approval to be distributed to appropriate flyer recipients. Alternatively in the example, the approval data received at module 802 can indicate that both the first and second flyer approvers approved distribution of the flyer. Therefore, it can be determined that the flyer does have approval to be distributed.

The example flowchart 800 continues to module 814, where appropriate recipients of the flyer are determined. The appropriate recipients of the flyer can be determined based on registrant data. For example the registrant data can indicate the entities associated with a flyer recipient. In one example, if an entity associated with a flyer recipient is the same as an entity associated with the flyer, as is determined at module 806, then the flyer recipient is an appropriate flyer recipient.

The example flowchart 800 continues to module 816, where the flyer is deployed to appropriate flyer recipients determined at module 814. The flyer can be deployed to appropriate flyer recipients based on registrant data. For example, the flyer can be deployed to appropriate flyer recipients through a preferred distribution channel, as indicated by registrant data.

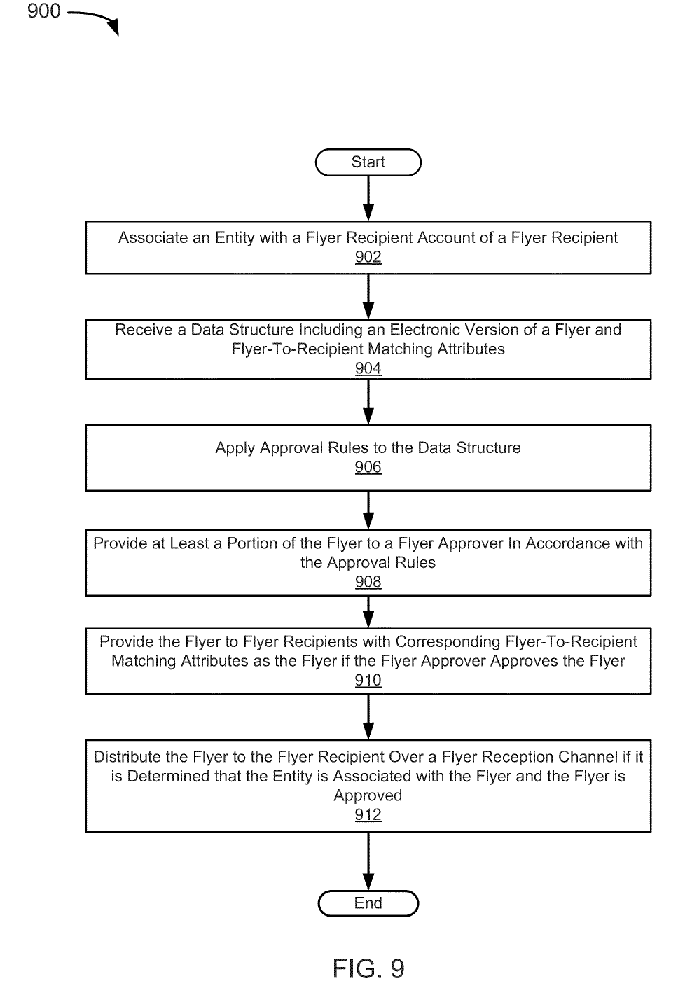

FIG. 9 depicts a flowchart 900 of an example of a method for approving and distributing flyers to flyer recipients. The flowchart begins at module 902 with associating an entity with a flyer recipient account. Depending upon implementation-specific or other considerations, an entity can be associated with a flyer recipient based on registrant data for the flyer recipient. Further depending upon implementation-specific or other considerations, an entity can be associated with a flyer recipient based on flyer-to-recipient matching attributes of the flyer recipient and included as part of registrant data for the flyer recipient. For example, flyer-to-recipient matching attributes can specify that a flyer recipient has a student at a specific school, and the school, serving as an entity, can be associated with the flyer recipient.

The flowchart 900 continues to module 904, where a data structure including an electronic version of a flyer is received. A data structure received at module 904 can also include flyer-to-recipient matching attributes of a flyer. Flyer-To-Recipient matching attributes of a flyer can be used to determine flyer recipients to whom to distribute the flyer.

The flowchart 900 continues to module 906, where approval rules are applied to the flyer. Approval rules can be specific to the flyer based on a type of the flyer, an entity that the flyer is associated with, or a flyer creator of the flyer. Approval rules can specify who needs to approve the flyer. Depending upon implementation-specific or other considerations, approval rules can be included an approval hierarchy and approval hierarchy conditions used in gaining approval for the flyer from appropriate flyer approvers.

The flowchart 900 continues to module 908, where at least a portion of the flyer is provided to a flyer approver in accordance with the approval rules. Depending upon implementation-specific or other considerations, a thumbnail of the flyer can be provided to the flyer approver. Further depending upon implementation-specific or other considerations, a flyer approver can be determined according to an approval hierarchy for the flyer.

The flowchart 900 continues to module 910, where the flyer is made available to a set of flyer recipients, including the flyer recipient, that have corresponding flyer-to-recipient matching attributes as those included in the data structure. The flyer can be made available if it is approved by the flyer approver. For example, the flyer can be made available to flyer recipients associated with a school, as indicated by flyer-to-recipient matching attributes for the flyer recipients, if the flyer is for the school, as indicated by flyer-to-recipient matching attributes for the flyer.

The flowchart 900 continues to module 912, where the flyer is distributed to the flyer recipient over a flyer reception channel, e.g. a preferred distribution channel, for the flyer recipient if it is determined that the entity is associated with the flyer and the flyer is approved. A preferred distribution channel can be determined from flyer reception channel indicators, included as part of registrant data of the flyer recipient.

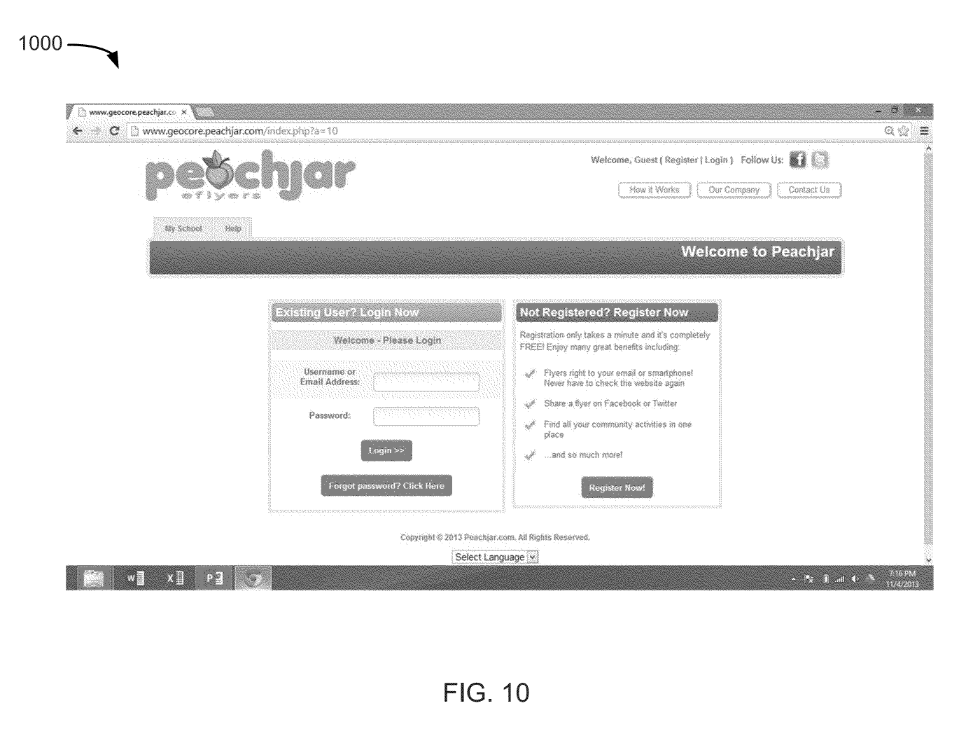

FIG. 10 depicts an example of a screenshot 1000 of an interface through which a user can login to a system for flyer approval and distribution. The user can be, but is not limited to, a flyer recipient, a flyer approver, a flyer generator, or an approval administrator who is part of an approval administration. In the example screenshot 1000, the interface includes a field in which a user can input a username or email address. Further in the example screenshot 1000, the interface also includes field in which a user can input a password to gain access to a system for flyer approval and distribution.

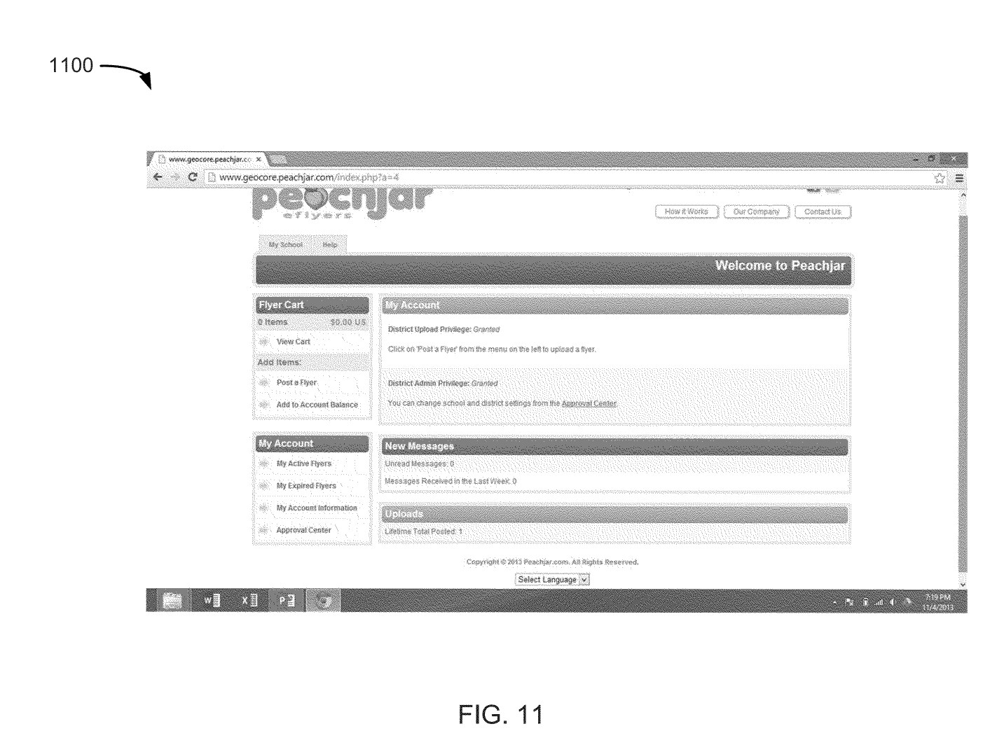

FIG. 11 depicts an example of a screenshot 1100 of a homepage of a user in a system for flyer approval and distribution. In the example screenshot 1100, the homepage includes a message region, where messages to the user can be displayed. Further in the example screenshot 1100, the homepage also includes an account summary region. The account summary region includes links to pages that display active flyers, expired flyers, account information, and an approval page. The homepage also includes a flyer cart region that includes links to a cart of a user that contains pending purchased flyers for distribution through the system.

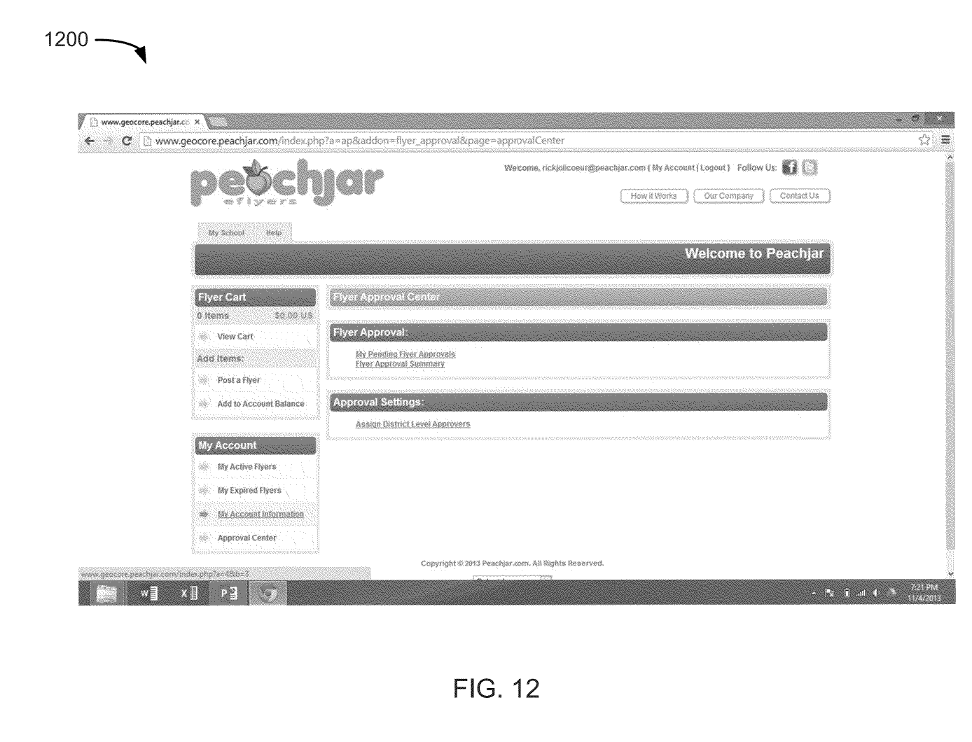

FIG. 12 depicts an example of a screenshot 1200 of a flyer approval homepage in a system for flyer approval and distribution. In the example screenshot 1200, the flyer approval homepage, includes a flyer approval region that includes links to flyers that are pending approval and a summary of flyers that are approved by a user. Additionally in the example screenshot 1200, the flyer approval homepage includes an approval settings region that includes a link to a flyer approver assignment page that allows a user to manage flyer approvers.

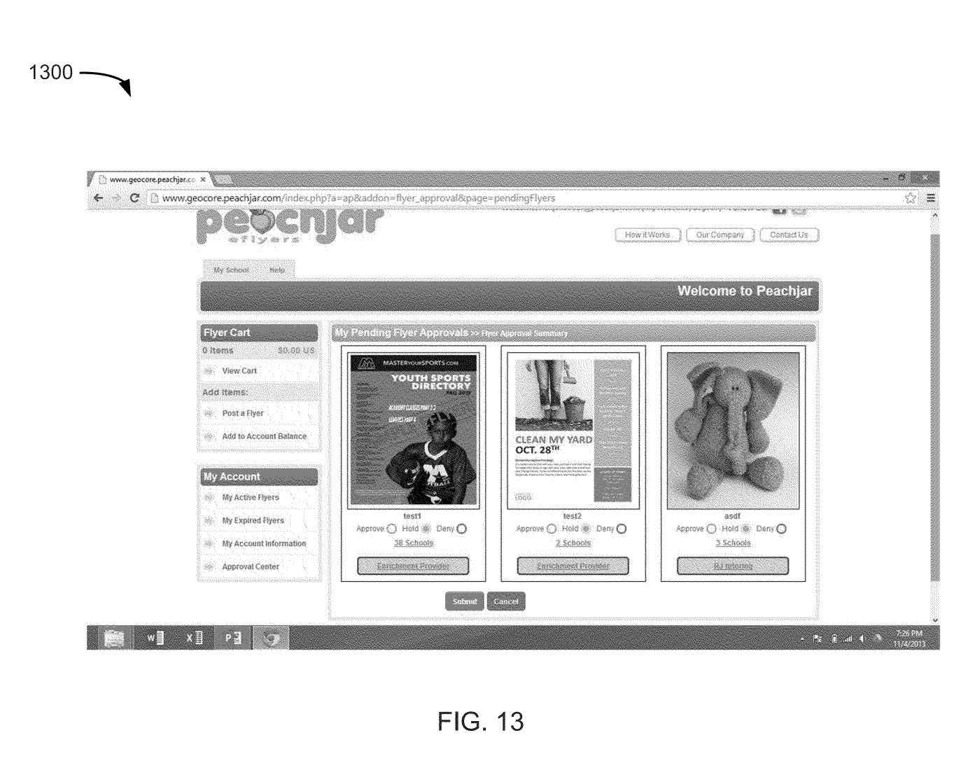

FIG. 13 depicts an example of a screenshot 1300 of a pending flyer approval page in a system for flyer approval and distribution. In the example screenshot 1300, the pending flyer approval page includes displays of pending flyers for approvals that are deployed to the flyer approver. In one example, the displayed are thumbnails of pending flyers. Also in the example screenshot 1300, the pending flyer approval page includes radio buttons that allow a flyer approver to indicate whether they approve or do not approve of the flyer. In the example screenshot 1300, the radio buttons include an approve button, a hold button, and a deny button.

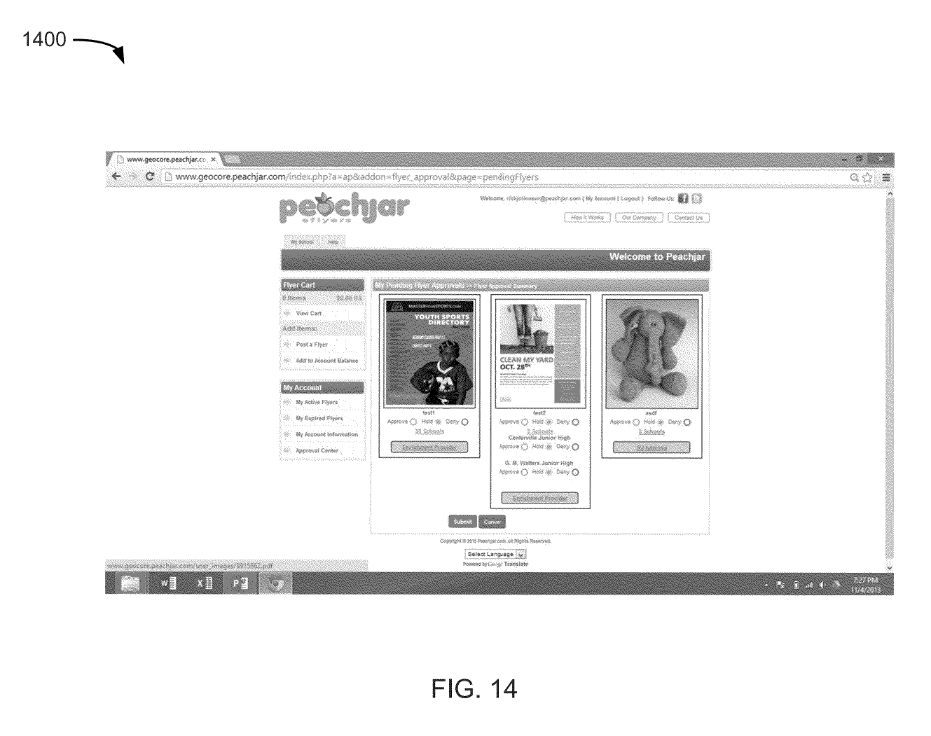

FIG. 14 depicts an example of a screenshot 1400 of another pending flyer approval page in a system for flyer approval and distribution. In the example screenshot 1400, the pending flyer approval page includes displays of pending flyers. Additionally, in the example screenshot 1400, the pending flyer page displays the entities, schools in the example screenshot 1400, for which the flyer approver needs to approve the pending flyers for. Further in the example screenshot 1400, the flyer approval page includes radio buttons that allow a flyer approve to indicate whether or not they approve the flyer for distribution to flyer recipients associated with each entity, school in the example screenshot.

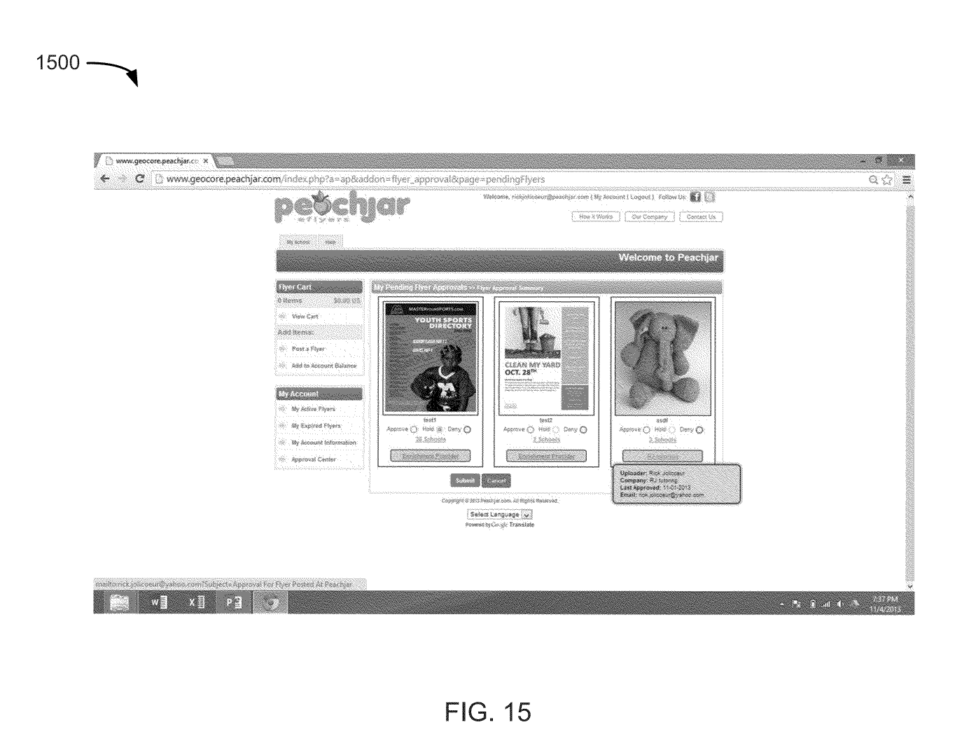

FIG. 15 depicts an example of a screenshot 1500 of another pending flyer approval page in a system for flyer approval and distribution. In the example screenshot 1500, the pending flyer approval page includes displays of pending flyers. Additionally in the example screenshot 1500, the flyer approval page includes a submit button that allows a flyer approver to submit whether they approve a flyer. Furthermore, in the example screenshot 1500, the flyer approval page includes a text box that includes information related to a pending flyer. The information relating the pending flyer, shown in the example screenshot 1500, includes the flyer generator or uploader, the company or entity that the flyer generator is associated with, the last time the flyer was approved, and the contact information of the flyer generator.

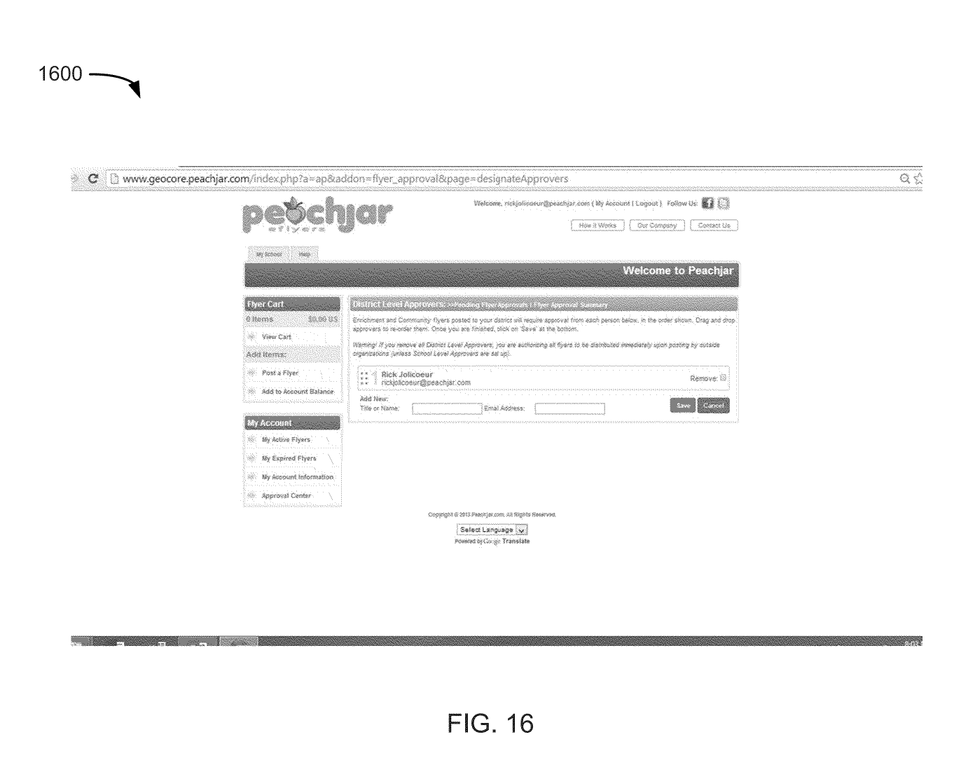

FIG. 16 depicts an example of a screenshot 1600 of a flyer approver assignment page in a system for flyer approval and distribution. In the example screenshot 1600, the flyer approver assignment page includes a title field in which an approval administrator can add the title of a new flyer approver. Further in the example screenshot 1600, the flyer approver assignment page includes a contact field in which an approval administrator can add the contact information, for example email address, of a new flyer approver. The flyer approver assignment page, in the example screenshot 1600, also includes a remove button through which an approval administrator can remove a flyer approver from being allowed to approve flyers.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
associating an entity of a plurality of entities with a flyer recipient account of a set of flyer recipient accounts, wherein the set of flyer recipient accounts have flyer-to-recipient matching attributes and flyer reception channel indicators;
receiving a data structure, wherein the data structure includes an electronic version of a flyer and a flyer-to-recipient matching attribute;
applying approval rules in association with the data structure;
providing at least a portion of the flyer to a flyer approver associated with the entity in accordance with the approval rules;
when it is determined the flyer is approved by the flyer approver, making the flyer available to the set of flyer recipients with the flyer-to-recipient matching attributes that correspond to the flyer-to-recipient matching attribute of the data structure;
if it is determined that the entity is associated with the flyer and that the flyer is approved, distributing the flyer to the flyer recipient by way of a flyer reception channel associated with the flyer reception channel indicator.

2. The method of claim 1, further comprising receiving registrant data in association with the flyer recipient account of the set of flyer recipient accounts, wherein the registrant data includes the flyer-to-recipient matching attribute or the flyer reception channel indicator.

3. The method of claim 1, further comprising determining the flyer recipient using the flyer-to-recipient matching attribute of the data structure.

4. The method of claim 1, wherein the entity includes a school or business of a plurality of schools or businesses with flyers to distribute to at least an overlapping subset of flyer recipients represented in the set of flyer recipient accounts, further comprising: when the flyer approver has provided approval data, determining from the approval data whether the flyer is approved by the flyer approver on behalf of the entity.

5. The method of claim 1, wherein the flyer is of a flyer type and the approval rules are specific to the flyer type.

6. The method of claim 1, wherein the flyer approver is a second flyer approver, further comprising:
determining an approval hierarchy and approval hierarchy conditions for the flyer based on input received from at least one approval administrator on behalf of the entity, wherein the approval hierarchy includes a first flyer approver associated with the entity and the second flyer approver;
modifying the data structure to indicate the flyer is approved in accordance with the approval hierarchy and the approval hierarchy conditions, wherein first flyer approver approval is obtained before the second flyer approver approval.

7. The method of claim 6, further comprising:
determining, using the approval hierarchy and the approval hierarchy conditions, the first flyer approver to approve the flyer;
providing at least a portion of the flyer to the first flyer approver;
receiving approval data from the first flyer approver;
when the first flyer approver has provided approval data, determining from the approval data whether the flyer is approved by the first flyer approver on behalf of the entity;
determining, using the approval hierarchy and the approval hierarchy conditions, the second flyer approver to approve the flyer;
receiving approval data from the second flyer approver;
when the second flyer approver has provided approval data, determining from the approval data whether the flyer is approved by the second flyer approver on behalf of the entity.

8. The method of claim 1, wherein the flyer approver is a second flyer approver, further comprising: selecting the second flyer approver as the flyer approver based on first flyer approver approval data received from a first flyer approver.

9. The method of claim 1, wherein:
the flyer approver is a second flyer approver;
an approval hierarchy includes a first flyer approver associated with the entity and the second flyer approver;
approval hierarchy conditions of the approval hierarchy specify approval for the flyer is required from the first flyer approver, from a third flyer approver as an alternative to the first flyer approver, and from the second flyer approver if the first flyer approver or the third flyer approver approves.

10. The method of claim 1, further comprising:
determining from the flyer recipient channel indicator a preferred distribution channel of the at least one flyer recipient;
distributing the flyer to the at least one flyer recipient through the preferred distribution channel.

11. The method of claim 1, wherein the at least a portion of the flyer includes a thumbnail of the flyer, further comprising: receiving the approval data from the flyer approver, the flyer approval data generated based, at least in part, on the thumbnail of the flyer.

12. The method of claim 1, wherein the thumbnail of the flyer includes an embedded link that provides the at least one flyer approver access to the flyer.

13. The method of claim 1, further comprising:
determining flyer types of flyers that the at least one flyer recipient wants to receive;
determining if a flyer type of the flyer is one of the flyer types of flyers that the at least one flyer recipient wants to receive;
if it is determined that the flyer type of the flyer is one of the flyer types of flyers that the at least one flyer recipient wants to receive and if it is determined that the flyer is approved, distributing the flyer to the at least one flyer recipient.

14. A system comprising:
an entity association determination engine configured to associate an entity of a plurality of entities with a flyer recipient account of a set of flyer recipient accounts, wherein the set of flyer recipient accounts have flyer-to-recipient matching attributes and flyer reception channel indicators;
an approval distribution engine configured to:
receive a data structure, wherein the data structure includes an electronic version of a flyer and a flyer-to-recipient matching attribute of the data structure;
apply approval rules in association with the data structure;
provide at least a portion of the flyer to a flyer approver associated with the entity in accordance with the approval rules;
a recipient distribution engine configured to:
make the flyer available to the set of flyer recipients with the flyer-to-recipient matching attributes that correspond to the flyer-to-recipient matching attribute of the data structure, when it is determined the flyer is approved by the flyer approver;
distribute the flyer to the flyer recipient by way of a flyer reception channel associated with the flyer reception channel indicator, if it is determined that the entity is associated with the flyer and that the flyer is approved.

15. The system of claim 14, further comprising a flyer recipient registration system configured to receive registrant data in association with the flyer recipient account of the set of flyer recipient accounts, wherein the registrant data includes the flyer-to-recipient matching attribute or the flyer reception channel indicator.

16. The system of claim 14, wherein the recipient distribution engine is further configured to determine the flyer recipient using the flyer-to-recipient matching attribute of the data structure.

17. The system of claim 14, wherein the entity includes a school or business of a plurality of schools or businesses with flyers to distribute to at least an overlapping subset of flyer recipients represented in the set of flyer recipient accounts, further comprising: an approval determination engine configured to determining from approval data provided from the flyer approver whether the flyer is approved by the flyer approver on behalf of the entity.

18. The system of claim 14, wherein the flyer is of a flyer type and the approval rules are specific to the flyer type.

19. The system of claim 14, wherein the flyer approver is a second flyer approver, further comprising:
an approval rules generation system configured to determine an approval hierarchy and approval hierarchy conditions for the flyer based on input received from at least one approval administrator on behalf of the entity, wherein the approval hierarchy includes a first flyer approver associated with the entity and the second flyer approver;
an approval determination engine configured to modify the data structure to indicate the flyer is approved in accordance with the approval hierarchy and the approval hierarchy conditions, wherein first flyer approver approval is obtained before the second flyer approver approval.

20. The system of claim 19, further comprising:
the approval distribution engine further configured to:
determine, using the approval hierarchy and the approval hierarchy conditions, the first flyer approver to approve the flyer;
provide at least a portion of the flyer to the first flyer approver;
receive approval data from the first flyer approver;
determine, using the approval hierarchy and the approval hierarchy conditions, the second flyer approver to approve the flyer;
receive approval data from the second flyer approver;
the approval determination engine further configured to:
determine from first approval data received from the first flyer approver whether the flyer is approved by the first flyer approver on behalf of the entity;
determine from second approval data received from the second flyer approver whether the flyer is approved by the second flyer approver on behalf of the entity.

21. The system of claim 14, wherein the flyer approver is a second flyer approver, the approval distribution engine further configured to select the second flyer approver as the flyer approver based on first flyer approver approval data received from a first flyer approver.

22. The system of claim 14, wherein:
the flyer approver is a second flyer approver;
an approval hierarchy includes a first flyer approver associated with the entity and the second flyer approver;
approval hierarchy conditions of the approval hierarchy specify approval for the flyer is required from the first flyer approver, from a third flyer approver as an alternative to the first flyer approver, and from the second flyer approver if the first flyer approver or the third flyer approver approves.

23. The system of claim 14, further comprising:
a preferred distribution channel determination engine configured to determine from the flyer recipient channel indicator a preferred distribution channel of the at least one flyer recipient;
the recipient distribution engine further configured to distribute the flyer to the at least one flyer recipient through the preferred distribution channel.

24. The system of claim 14, wherein the at least a portion of the flyer includes a thumbnail of the flyer, the approval distribution engine further configured to receive the approval data from the flyer approver, the flyer approval data generated based, at least in part, on the thumbnail of the flyer.

25. A system comprising:
a means for associating an entity of a plurality of entities with a flyer recipient account of a set of flyer recipient accounts, wherein the set of flyer recipient accounts have flyer-to-recipient matching attributes and flyer reception channel indicators;
a means for receiving a data structure, wherein the data structure includes an electronic version of a flyer and a flyer-to-recipient matching attribute of the data structure;
a means for applying approval rules in association with the data structure;
a means for providing at least a portion of the flyer to a flyer approver associated with the entity in accordance with the approval rules;
a means for making the flyer available to the set of flyer recipients with the flyer-to-recipient matching attributes that correspond to the flyer-to-recipient matching attribute of the data structure, when it is determined the flyer is approved by the flyer approver;
a means for distributing the flyer to the flyer recipient by way of a flyer reception channel associated with the flyer reception channel indicator, if it is determined that the entity is associated with the flyer and that the flyer is approved.
